(19) United States
(12) Patent Application Publication
(10) Pub. No.: US 2002/0073783 A1
(43) Pub. Date: Jun. 20, 2002

(54) Pressure sensor

(75) Inventors: Leslie Bruce Wilner, Palo Alto, CA (US); Ronald I. Poff, Mission Viejo, CA (US)

Correspondence Address: Robert T. Conway, Esq., HAMILTON, BROOK, SMITH & REYNOLDS, P.C., 530 Virginia Road, P.O. Box 9133, Concord, MA, 01742-9133, US

(73) Assignee: Endevco Corporation, San Juan Capistrano, CA

(21) Appl. No.: 09/982,115

(22) Filed: Oct. 17, 2001

Related U.S. Application Data
(60) Provisional application No. 60/241,294, filed on Oct. 18, 2000.

(51) Int. Cl. G01L 13/02

(52) U.S. Cl. 73/716

(57) ABSTRACT

A silicon pressure sensor includes a bossed diaphragm provided with a planar surface. The bossed diaphragm converts a pressure applied to the planar surface to a force, and transmits the force through a central boss to a sensing diaphragm positioned next to the bossed diaphragm. The sensing diagram converts the force to an electrical signal. To fabricate the sensor, both diaphragms are formed in large numbers on silicon wafers and then bonded together before being separated as individual, complete sensors.

### RELATED APPLICATION(S)

This application claims the benefit of U.S. Provisional Application No. 60/241,294, filed on Oct. 18, 2000, the entire teachings of which are incorporated herein by reference.

### BACKGROUND

In certain medical procedures, pressure sensors are used to measure physiological pressures. For example, Aplanation Tonometry measures the pressures within the eyeball. In this procedure, the curved surface of the eyeball is locally flattened by an outer flattening surface of the measuring device. Accordingly, pressure-retaining forces in the outer membrane of the eyeball are nulled and the true pressure of the interior fluid is applied to the flattening surface.

Devices which have been employed in Aplanation Tonometry procedures include piston-cylinder devices. In these devices, the force is applied to a flat surface of the piston. Another device that has been used are silicon piezoresitive sensors. One surface of the piezoresistive sensor is placed against the eyeball, while another surface of the sensor includes piezoresistive gages, electrical connections, and support electronics.

### SUMMARY

When using piston-cylinder devices to perform pressure measurements, the interface between the piston and the surrounding hole of the cylinder is subject to stiction, and is acutely sensitive to particulate contamination. Also, the mass of the piston makes the device subject to damage from mechanical shocks. As for piezoresitive sensors, the surface presented to the biological medium, such as the eyeball, is highly contoured. Thus, a thin, sensitive region of that surface is surrounded by a thick, sturdy rim. Although the other surface remote from the pressure medium is substantially planar, this remote surface includes the electrical connections to the sensor such as wire bonds or plated leads that necessarily rise substantially above the plane. Connection to the remote surface's circuitry through the thickness of the rim is possible, but such a design approach would leave the gages and electrical traces exposed to the medium. Covering the gages and traces with a protective coating would diminish the sensitivity and stability of the sensor.

In accordance with the present invention, a silicon pressure sensor includes a bossed diaphragm provided with a planar surface. The bossed diaphragm converts a pressure applied to the planar surface to a force, and transmits the force through a central boss to a sensing diaphragm mated to the bossed diaphragm. The sensing diaphragm converts the force to an electrical signal.

In one aspect of the invention, a pressure sensor assembly includes two diaphragms that are positioned next to each other. A first diaphragm has a surface for placing against a medium from which the pressure is to be measured. This first diaphragm converts the pressure to a force and transmits this force to a second diaphragm which has electronic circuitry for measuring the force.

Embodiments of this aspect can include one or more of the following features. The diaphragms are made from silicon and can be attached to a support shaft made from ceramic material. The shaft can have grooves which are coated with a conductive material to facilitate transmitting electrical signals between the sensor assembly and a mother unit, for example, a personal computer. The sensor assembly can be mounted to a housing made of hard, machinable, corrosion resistant material, such as stainless steel, titanium, or Monel, and can be connected to a circuit board.

The first diaphragm can include an outer rim and a central boss which together define an annular recessed region. The second diaphragm can include an outer rim, a side island, and a central island. The sensor assembly can include a strain gage spaced from a narrow groove defined by the outer rim of the second diaphragm and the side island. The side island and the central island can define a second groove. Spaced from this second groove may be another strain gage.

In another aspect of the invention a method of fabricating the pressure sensor includes providing a first wafer from which a plurality of transmitting diaphragms are fabricated, and providing a second wafer from which a plurality of sensor diaphragms are fabricated. A plurality of strain gages are formed on the second wafer with each of the strain gages corresponding to an individual sensor diaphragm. Cavities are etched in the first wafer for each of the transmitting diaphragms and in the second wafer for each of the sensor diaphragms. The two wafers are bonded together and the individual sensor modules then separated from the bonded wafers. Accordingly, both diaphragms are formed in large numbers on silicon wafers and then bonded together before being separated as individual, complete sensors.

In some embodiments, the first and second wafers are single silicon crystal wafers with a (100) orientation. The forming of the plurality of strain gages can be performed with a diffusion process, or an ion implantation process. The bonding of the two wafers can be performed with a direct wafer bonding process, a gold-gold bonding process, or a solderglass process.

A related aspect of the invention involves using the pressure sensor to measure the pressure of an eyeball. The method includes placing a protective covering over a contact surface of the pressure sensor, and urging the covered contact surface against the patient's eyeball to impart a force against the eyeball. The strain gage is driven with an excitation voltage supplied by a mother unit or control unit such as a personal computer. As the contact surface is urged against the eyeball, a strain is induced in the strain gage thereby generating a signal voltage which is between about 2% to 4% of the excitation voltage. The signal voltage is then converted to a pressure by the control unit.

Embodiments of this invention may have one or more of the following advantages. The pressure sensor lends itself to MEMS (micro-electromechanical-systems) fabrication technologies and is therefore easy and inexpensive to fabricate. The sensor is lightweight, easy to handle, and is easy to clean and calibrate. The signal voltage is easily related to the excitation voltage because there is a linear relationship between the two voltages. The pressure sensor is reliable and requires less than one second to power up. Further, the power consumption of the pressure sensor is low.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of a pressure sensor in accordance with an embodiment of the present invention.

FIG. 2A is a side view of a sensor assembly in accordance with an embodiment of the present invention.

FIG. 2B is a perspective view of a sensor module of the sensor assembly of FIG. 2A.

FIG. 2C is a perspective view of a support shaft of the sensor assembly of FIG. 2A.

FIG. 3A is a side cross-sectional view of the sensor module taken on line 3A-3A of FIG. 2B.

FIG. 3B is a view of the sensor module take on line 3B-3B of FIG. 3A.

FIG. 3C is an illustration of an electrical circuit printed on a sensing diaphragm of the sensor module of FIG. 2B.

FIG. 4 is schematic illustration of a four-arm Wheatstone bridge strain gage circuitry of the pressure sensor of FIG. 1.

FIG. 5 is a flow diagram of a sequence of steps for making the pressure sensor.

FIG. 6 is a flow diagram of a sequence of steps for calibrating the pressure sensor.

FIG. 7 is a flow diagram of a sequence of steps for using the pressure sensor.

### DETAILED DESCRIPTION OF THE INVENTION

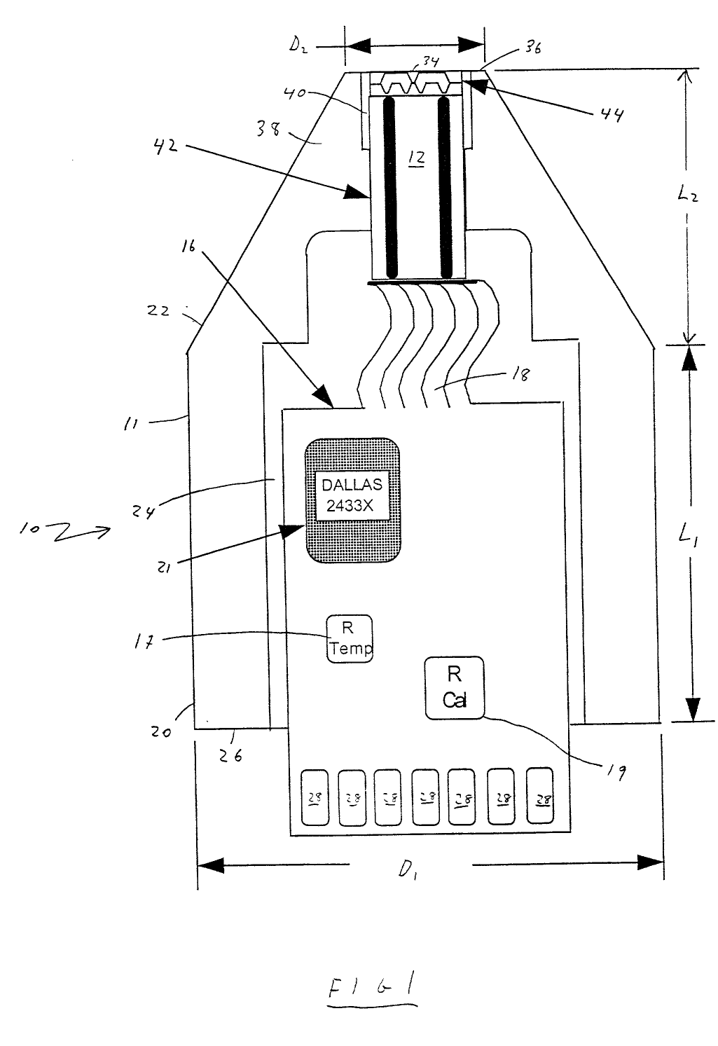

FIG. 1 illustrates a pressure sensor 10 according to one embodiment of the invention. Pressure sensor 10 includes a housing 11, a sensor assembly 12 mounted in the housing, and a circuit board 16 connected to the sensor assembly 12 by a flexible cable 18. The circuit board 16 includes a temperature compensation resistor 17, a calibration resistor 19, and an EEPROM 21. A set of connection pads 28 facilitate connecting the circuit board 16 to a mother unit such as, for example, a personal computer.

The housing 11, typically made from steel, has a cylindrical section 20 and a conical section 22. The cylindrical section 20 defines a hollow region 24 in which the circuit board 16 generally resides. The circuit board 16 extends past a bottom end 26 of the housing 11 exposing the connection pads 28. The sensor assembly 12 is cemented, for example, by epoxy, to the housing 11 and is positioned so that a top surface 34 of the sensor assembly 12 is coplanar with a top end 36 of the housing 11. An end region 38 of the housing 11 and the sensor assembly 12 define an annular space 40 to isolate stresses from the sensor assembly 12. The annular space 40 is filled, for example, by soft silicone gel to prevent debris from entering the annular space 40.

The cylindrical section 20 has an outer diameter, D₁, of about 0.375 inch, and a length, L₁, of about 0.3 inch. The conical section 22 has a length, L₂, of about 0.2 inch and tapers from the cylindrical section 20 to the top end 36 which has a diameter, D₂, of about 0.125 inch.

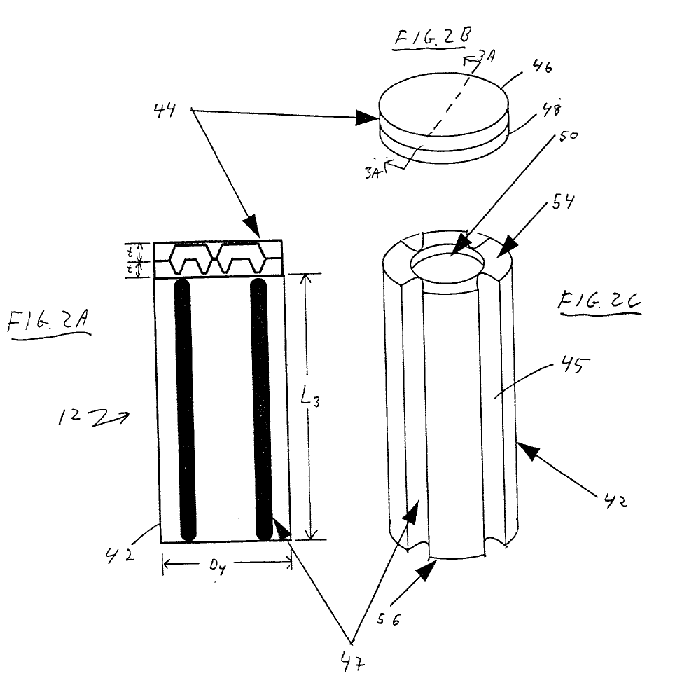

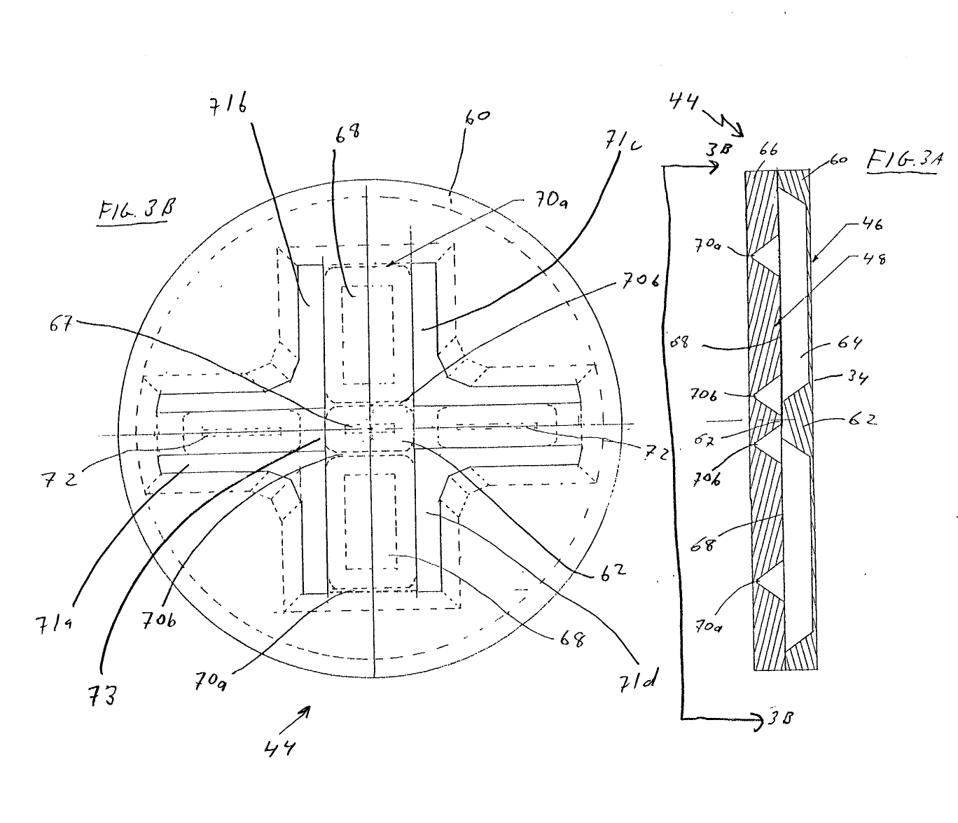

Referring further to FIGS. 2A-C, the sensor assembly 12 includes a support shaft 42 and a sensor module 44 attached to the support shaft 42. The sensor module 44 includes a bossed diaphragm 46 and a sensing diaphragm 48 located next to the bossed diaphragm 46. The support shaft 42 has a recessed opening 50 to assure freedom of motion for the deflecting portions of the sensor module 44. The support shaft 42 also includes a set of four grooves 45 equally spaced about the outer surface of the support shaft 42 and extending along the length of the shaft.

The support shaft 42 has a length, L₃, of about 0.15 inch. The support shaft 42 and both the bossed diaphragm 46 and the sensing diaphragm 48 have an outer diameter, D₄, of about 0.08 inch. Each of the bossed diaphragm 46 and the sensing diaphragm 48 has a thickness, t, of about 0.005 inch. The recessed opening 50 has a depth that can vary from about 0.0001 inch to about 0.002 inch and has a diameter of about 0.07 inch.

The support shaft 42 is typically made from ceramic material. To provide an electrical conductive path between the sensor module 44 and the circuit board 16, the grooves 45 are coated with a conductive material 47, such as a metallic material, and a the top surface 54 and a bottom surface 56 are coated with silk screen pads to make the electrical connections between the module 44 and the conductive material 47 and between the conductive material 47 and the circuit board 16, respectively. Alternatively, the sensing diaphragm 48 and the flexible cable 18 are soldered to the top surface 54 and the bottom surface 56 of the support shaft 42, respectively.

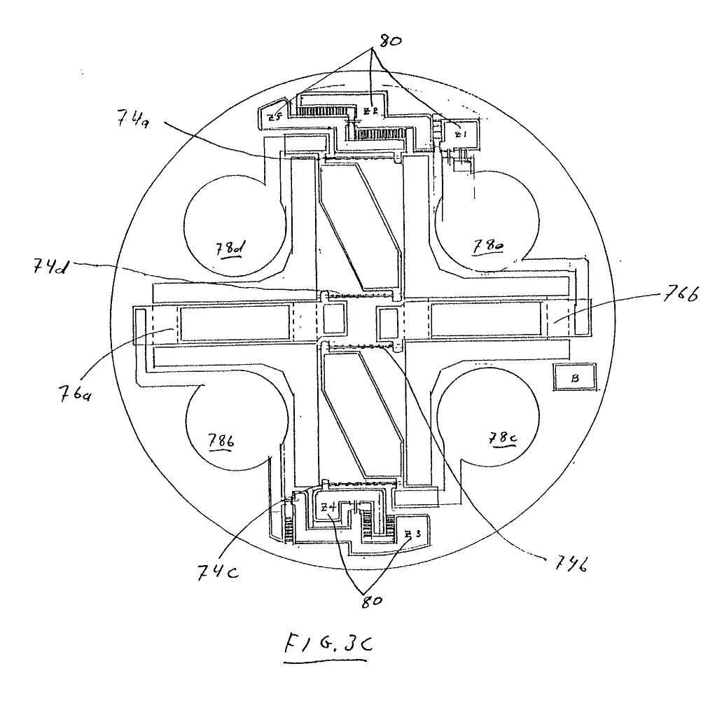

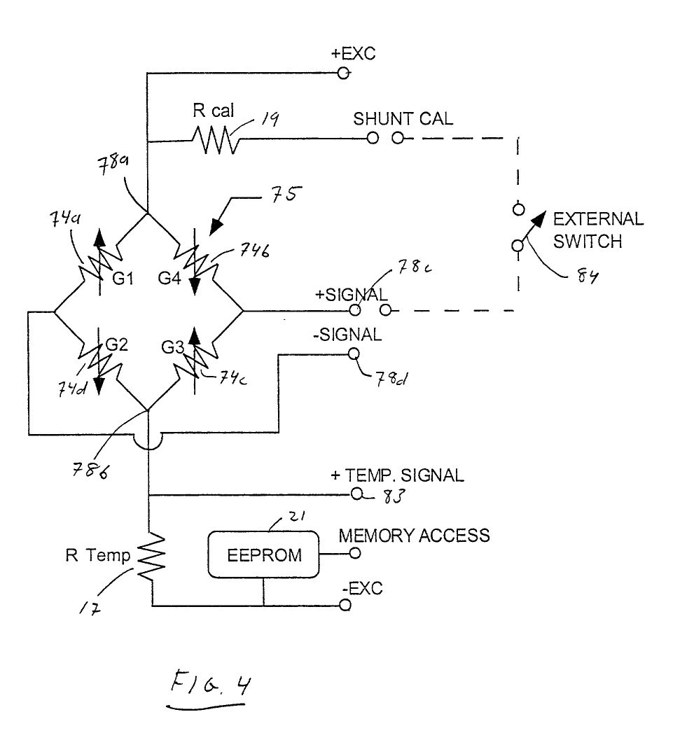

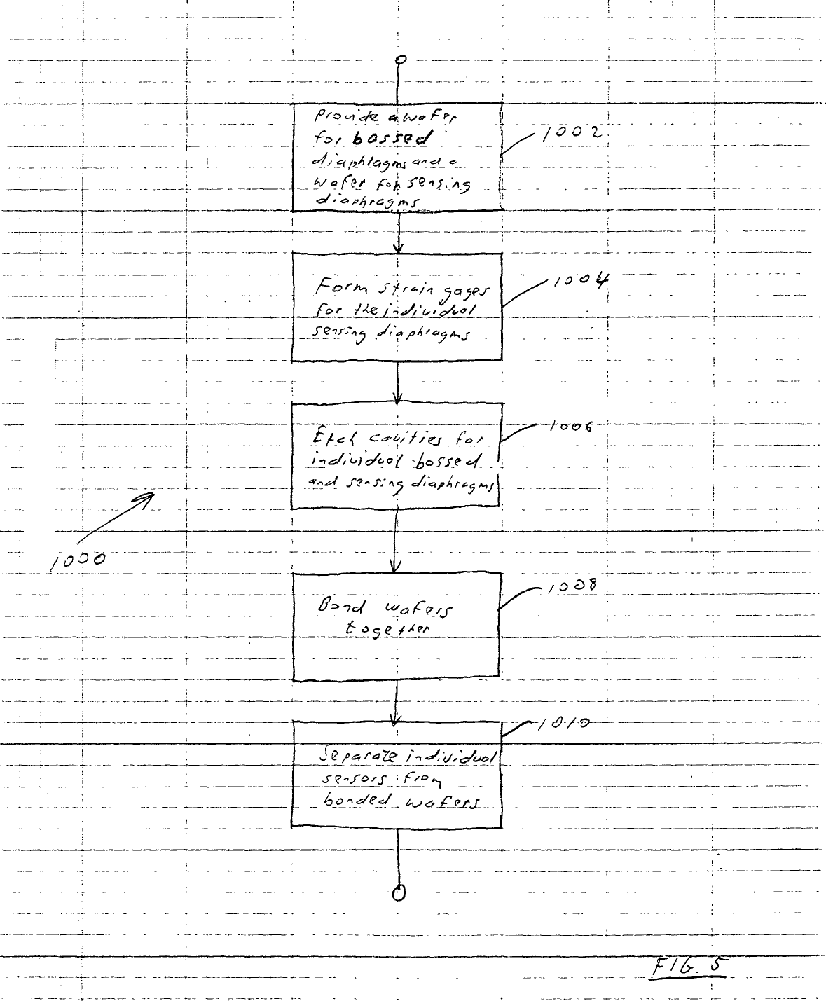

Referring now to FIGS. 3A and 3B, the bossed diaphragm 46 includes an outer reinforced rim 60 and a central boss 62 which together define an annular recessed region 64. The sensing diaphragm 48 includes an outer rim 66, a central island 67, a pair of large side islands 68, and a pair of narrower lateral islands 72. The outer rim 66 of the sensing diaphragm 48 and each island 68 define an outer narrow groove 70a. A set of inner narrow grooves 70b is defined between each island 68 and the central island 67. The outer narrow grooves 70a and the inner narrow grooves 70b are collectively referred to as narrow grooves 70. The sensing diaphragm 48 is also provide with a set of four openings 71a, 71b, 71c, and 71d which permit an X-shaped portion 73 of the diaphragm 48 to flex and hence the central island 67 to move out of the page when a force is transmitted from the central boss 62 to the central island 67.

FIG. 3C shows a printed electrical circuit of the sensing diaphragm 48. As shown, a set of strain gages 74a, 74b, 74c, and 74d (collectively referred to as strain gages 74) are positioned opposite each of the narrow grooves 70 illustrated in FIG. 3B. The lateral islands 72 (see FIG. 3B) of the sensing diaphragm 44 provide mechanical support for a pair of electrical connections 76a and 76b which along with another pair of electrical connections 76c and 76d connect strain gages 74 to a set of contact pads 78a, 78b, 78c, and 78d (collectively referred to as pads 78). Thus, the pad 78b is connected through one set of trim resistors 80a to the strain gage 74c and via the electrical connection 76a to the strain gage 74d, the pad 78a is connected through a second set of trim resistors 80b to the strain gage 74a and via the electrical connection 76b to the strain gage 74b, the pad 78c is connected to the strain gage 74c and via the electrical connection 76b to the strain gage 74b, and the pad 78d is connected to the strain gage 74a and via the electrical connection 76c to the strain gage 74d. In the present embodiment, the pads 78 are aligned with the grooves 45 of the support shaft 42 and the pads 78 and the grooves 45 are electrically connected by solder.

Referring also to FIG. 4, the strain gages 74 are connected together to form a four-arm Wheatstone bridge 75. The mother unit or control unit provides an excitation voltage, typically around 6 volts, across the excitation terminals, EXC, and the signal output from the bridge is provided at the signal terminals or pads 78c and 78d. The ambient temperature is supplied to a temperature terminal 83. As illustrated in FIG. 4, the temperature compensation resistor 17, the calibration resistor 19, and the EEPROM 21 of the circuit board 16 as well as an external switch 84 are electrically connected to the Wheatstone bride arrangement 75.

The resistance of each of strain gages 74 can range from about 100 Ω to about 2000 Ω. Because the Wheatstone bridge has two sets of resistors (each set consisting of a pair of resistors serially connected) connected in parallel, the overall resistance of the bridge arrangement is the same as an individual leg. The temperature compensation resistor 17 can be a thick film thermistor or alternatively made from a platinum wire. The calibration resistor 19 is typically ten to twenty times the resistance of the shunted strain gage 74b. Thus the calibration resistor varies in resistance from about 1000 Ω to about 20,000 Ω. Also, the circuitry includes a set of trim resistors 80 (FIG. 3C) which compensate for manufacturing variations so that the bridge arrangement remains balanced.

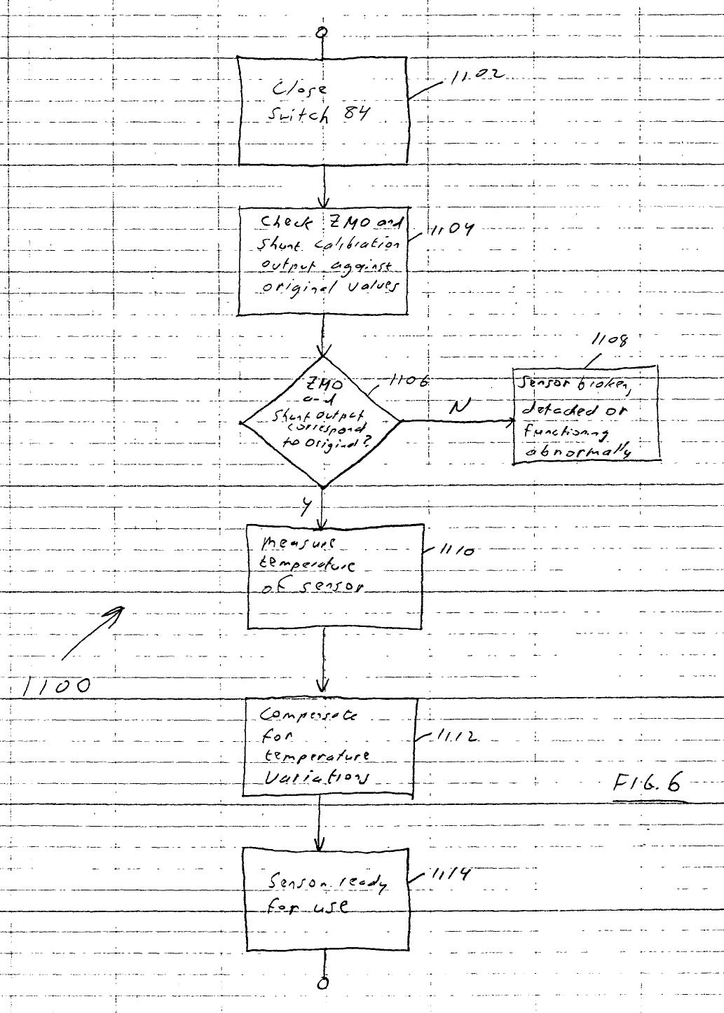

Referring now to FIG. 5, there is a shown a sequence of steps 1000 performed to fabricate the sensor module 44. For economical purposes, the bossed and the sensor diaphragms 46, 48 are formed in large numbers on silicon wafers and bonded together before being separated as individual, complete sensor modules 44. The fabrication process can use MEMS (micro-electromechanical-systems) technology. The fabrication process begins in a step 1002 with a respective wafer for the bossed diaphragms 46 and the sensing diaphragms 48. The wafers are typically single silicon crystal wafers having a (100) orientation and a thickness of approximately 0.005 inch.

Next in a step 1004, the strain gages 74 are formed for each of the individual sensor diaphragms 48, for example, by a diffusion process or an ion implantation process. The strain gages 74 are atomically continuous with the surrounding single crystal silicon, but are electrically separated from the body of the sensing diaphragm 48 by P/N junctions. Typically the strain gages are P type and the body N type materials.

In a step 1006, the cavities of each diaphragm 46, 48 are made by etching techniques, usually late in the fabrication process to permit the use of planar processes for all the fabrication steps.

Next in a step 1008, the two wafers and hence the bossed and the sensing diaphragms 46, 48 are bonded together. Several techniques are available for the bonding process. The diaphragms can be bonded together by a direct wafer bonding, in which the two silicon wafers are fused together to form a single silicon crystal. Another technique is gold-gold bonding in which metal film is deposited on both surfaces to be bonded. The film consists of an under layer of reactive metal and an outer surface layer of pure gold. At temperatures of approximately 300° C. and pressures of about 500 psi the gold films weld to each other. Alternatively, a solderglass technique can be used to bond the diaphragms together. In such a process, a layer of low-temperature glass is deposited on a surface of one of the wafers and the unwanted glass is etched off. The two wafers are then bonded by remelting the solderglass.

After the bonding process, in a step 1010, the individual sensor modules 44 are separated apart.

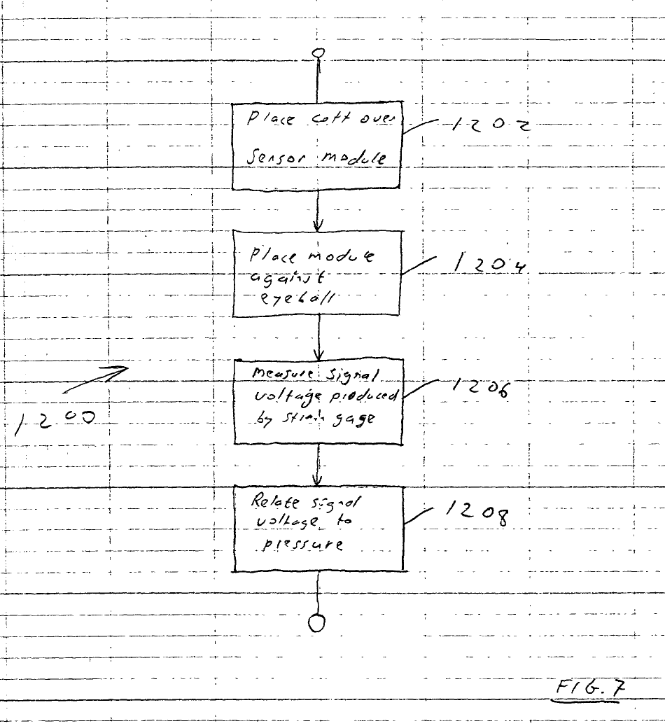

Prior to using the sensor 10, the bridge arrangement for the strain gages 74 is calibrated as described in the sequence of steps 1100 shown in FIG. 6. In a step 1102, a user switches the external switch 84 to the closed position so that the calibration resistor 19 is placed in parallel with the shunted strain gage 74b. In a step 1104 and in a decision step 1106, the shunt calibration process determines if the pressure sensor 10 is electrically intact. The zero measurement output (ZMO), corresponding to the unstrained output of the instrument, and the shunt calibration output are typically checked against the original values stored in the EEPROM 21 at the time the pressure sensor is manufactured. This ensures that the sensor assembly 12 has not experience any drastic changes. (The EEPROM 21 is a non-volatile memory IC chip such as, for example, a Dallas DS2433X.) The calibration process can be performed by the mother unit such that the process is automated.

Thus in a step 1108, the calibration procedure is able to detect broken sensors since such sensors will cause drastic resistance changes. The procedure will also detect an electrically detached sensor or abnormal sensor drift.

On the other hand, if the bridge is intact and the ZMO values correspond to the original values, the readings from the bridge should be consistent over time, and in a step 1110, the temperature of the sensor is accurately tracked by measuring the voltage across the temperature compensation resistor 17. With this information and using generic compensation coefficients, corrections for temperature variations is made to the bridge arrangement in a step 1112. The voltage corresponding to the room temperature could also be stored in the EEPROM 21. The sensor 12 is then available for use as indicated in the step 1114.

A flow diagram 1200 showing the sequence of steps for the use of the sensor 10 is next shown in FIG. 7. In a step 1202, a operator first places an instrument cott over the surfaces 34 and 36 (FIG. 1) of the sensor 10. The instrument cott is typically a piece of disposable rubber covering that protects the eyeball from contaminants from the pressure sensor and also protects the instrument from liquids produced by the patient's eye.

Next, the operator powers up the electronics for the sensor 10, which takes less than one second, and the mother unit supplies a sufficient excitation voltage to the strage gages 74. Then, in a step 1204, the operator places the surface 34 of the sensor module 44 against the eyeball thereby imparting a pressure upon the surface 34. The pressure is converted into a force that is transmitted through the central boss 62 of the bossed diaphragm 46 to the central island 67 of the sensing diaphragm 48. The applied force deflects the central island 67 which causes each island 68 to tilt. The tilting islands create bending strains along the narrow grooves 70. Thus, in a step 1207, the strain gages 74 and associated circuitry converts the strain to an electrical signal that is transmitted to a mother unit for observation by the observer. The signal voltage is about 2% to 4% of the excitation voltage. Note that there is a linear relationship between the signal voltage and the excitation voltage. Hence, for an excitation voltage of about 6 V, a pressure of about 3 psi would produce a signal voltage of approximately 200 mV. The sensor 10 has a very low power requirement. For example, in a typically application, the sensor 10 uses about 20 mwatts to operate.

Next, in a step 1208, the signal voltage is related or converted to a pressure. The sensor 10 has a dynamic range up to about 7 psi. It should be noted that the sensor 10 can withstand an overpressure of about 30 psi.

In other embodiments, the sensor assembly 12 is provided with a layer of silicon placed between the sensor module 44 and the support shaft 42. This layer can be thicker than either the bossed diaphragm 46 or the sensing diaphragm 48. The additional layer provides a buffer for the thermal expansion difference between the silicon of the sensor module 44 and the ceramic of the support shaft 42. Note that the electrical connection via wires or any other suitable conductive path is maintained between the sensor module 44 and the support shaft 42 through the layer of silicon.

The present embodiment can be used in applications other than eyeball tonometry. For example, in aerodynamic and hydrodynamic measurements, it is desirable that the measuring device not have any discontinuity in the surface over which the fluid is flowing. Because of its planar surface, the present pressure sensor can serve that need especially well.

While this invention has been particularly shown and described with references to preferred embodiments thereof, it will be understood by those skilled in the art that various changes in form and details may be made therein without departing from the scope of the invention encompassed by the appended claims.

What is claimed is:

1. A sensor assembly for measuring pressure, comprising:
a first diaphragm having a surface which contacts a medium, the medium applying a pressure to the first diaphragm; and
a second diaphragm positioned next to the first diaphragm such that the pressure applied to the first diaphragm is transmitted as a force to the second diaphragm, the second diaphragm including an electronic circuit for converting the pressure applied to the sensor assembly to an electrical signal.

2. The sensor assembly of claim 1, further comprising a support shaft attached to the second diaphragm.

3. The sensor assembly of claim 2, wherein the support shaft is made of ceramic material.

4. The sensor assembly of claim 2, wherein the support shaft includes a plurality of grooves disposed about the outer surface of the support shaft, the grooves being spaced apart and extending along the length of the support shaft.

5. The sensor assembly of claim 4, wherein the grooves are coated with a metallic conductive material along the length of the groove.

6. The sensor assembly of claim 1, wherein the first diaphragm and the second diaphragm are made of silicon.

7. The sensor assembly of claim 1, wherein the first diaphragm and the second diaphragm each has a diameter of about 0.08 inch.

8. The sensor assembly of claim 1, where the first diaphragm and the second diaphragm each has a thickness of about 0.005 inch.

9. The sensor assembly of claim 2, wherein the support shaft is mounted to a housing for holding the sensor assembly.

10. The sensor assembly of claim 9, wherein the housing is made of hard, machinable, corrosion resistant material.

11. The sensor assembly of claim 10, wherein the material is stainless steel.

12. The sensor assembly of claim 10, wherein the material is titanium.

13. The sensor assembly of claim 10, wherein the material is Monel.

14. The sensor assembly of claim 2, wherein the electronic circuit of the second diaphragm is electrically connected to the support shaft.

15. The sensor assembly of claim 14, further comprising a circuit board having a flexible connector connected to the support shaft so that electrical signals can be transmitted between the circuit board and the electronic circuit.

16. The sensor assembly of claim 1, wherein the first diaphragm includes an outer rim and a central boss, the outer rim and the central boss defining an annular recessed region.

17. The sensor assembly of claim 16, wherein the second diaphragm includes an outer rim, a central island and a side island adjacent to the central island, the outer rim and the side island defining a first narrow groove, and the side island and central island defining a second narrow groove.

18. The sensor assembly of claim 17, further comprising a first strain gage spaced from the first narrow groove, and a second strain gage spaced from the second narrow groove.

19. The sensor assembly of claim 18, wherein the first strain gage has an axis aligned substantially parallel to the first narrow groove, and the second strain gage has an axis aligned substantially parallel to the second narrow groove.

20. The sensor assembly of claim 18, further comprising a third strain gage and a fourth strain gage connected to the first and second strain gages to form a Wheatstone bridge.

21. The sensor assembly of claim 17, wherein the first and second diaphragms are arranged such that the force is transmitted from the boss of the first diaphragm to the central island of the second diaphragm.

22. A method of fabricating a pressure sensor module, comprising:
providing a first wafer from which a plurality of bossed diaphragms are fabricated;
providing a second wafer from which a plurality of sensor diaphragms are fabricated;
forming a plurality of strain gages on the second wafer, each of the strain gages corresponding to an individual sensor diaphragm;
etching cavities in the first wafer for each of the bossed diaphragms and in the second wafer for each of the sensor diaphragms;
bonding the first wafer to the second wafer; and
separating the individual sensor modules from the bonded wafers.

23. The method of claim 22, wherein the first and second wafers are single silicon crystal wafers with a (100) orientation.

24. The method of claim 22, wherein forming the plurality of strain gages is performed with a diffusion process.

25. The method of claim 22, wherein forming the plurality of strain gages is performed with an ion implantation process.

26. The method of claim 22, wherein bonding is performed with a direct wafer bonding process.

27. The method of claim 22, wherein bonding is performed with a gold-gold bonding process.

28. The method of claim 22, wherein bonding is performed with a solderglass process.

29. A method of using a pressure sensor to measure the pressure of an eyeball, comprising:
placing a protective covering over a contact surface of the pressure sensor having a bossed diaphragm and a sensor diaphragm;
urging the covered contact surface against the patient's eyeball which imparts a force upon the contact surface, the force being transmitted from the bossed diaphragm to the sensor diaphragm;
measuring a signal voltage from a strain gage of the sensor diaphragm that is created by straining the gage when the contact surface is urged against the eyeball; and
converting the signal voltage to a pressure.

30. The method of claim 29, wherein the signal voltage is between about 2% to 4% of an excitation voltage of the strain gage.
